(19) United States
(12) Patent Application Publication
(10) Pub. No.: US 2009/0172264 A1
(43) Pub. Date: Jul. 2, 2009

(54) SYSTEM AND METHOD OF INTEGRATING DATA ACCESSING COMMANDS

(75) Inventors: Chien-Ping Chung, Taipei (TW); Chia-Hsin Chen, Taipei (TW); Ming-Che Liu, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASMEDIA TECHNOLOGY INC., Taipei (TW)

(21) Appl. No.: 12/238,152

(22) Filed: Sep. 25, 2008

(30) Foreign Application Priority Data
Dec. 28, 2007 (TW) 096150923

(51) Int. Cl. G06F 12/02; G06F 12/00

(52) U.S. Cl. 711/103; 711/158; 711/E12.008; 711/E12.001

(57) ABSTRACT

A data accessing command integration method includes the following steps. Firstly, M data accessing commands are sequentially received through a bus, wherein N data accessing commands contained in the M data accessing commands have the same command type and comply with a sequential address relationship. Next, the N data accessing commands are re-ordered according to the addressing sequence, so that a first data corresponding to the re-ordered N data accessing commands are sequentially accessed in the data memory.

### FIELD OF THE INVENTION

The present invention relates to a method of integrating data accessing commands, and more particularly to a method of integrating data accessing commands to be applied to a flash memory.

### BACKGROUND OF THE INVENTION

In computer science, random access is the ability to access an arbitrary element of a sequence in equal time; whereas, sequential access means that a group of elements are accessed in a predetermined sequence. In memory (especially flash memory) applications, sequential access is more efficient than random access. For example, if the access latency for the random access is 25 μs, the access latency for the sequential access may be reduced to 25 nS. For accessing data in sequential access, the data are read from or written into the flash memory in pages (1 page=2 k to 8 k bytes in size) at a time in order to enhance the access efficiency of the flash memory. The quantity of memory blocks is typically determined by the size of the memory device. Each block consists of a number of pages (e.g. 64 pages). As known, a block erase operation should be done before data are firstly written into the flash memory such that data erased in blocks. When a reading or writing operation is performed on a page basis, the block erase operation should be performed on a block basis. In a case that it takes 200 μs to write an entire page, the time period of performing the block erase operation needs 1.5 mS. That is, sequential access is very important to be applied to the flash memory.

Furthermore, Advanced Technology Attachment (ATA) bus is primarily designed for transfer of data between a host terminal and a flash memory. According to the ATA protocols, only one data reading or writing command is issued by the host when the host accesses data. In addition, the data reading or writing command is transferred in sectors (a sector=256 Words=512 bytes=0.5 kB) at a time. When the host issues a data reading command to the flash memory, the host will not issue the next data reading or writing command to the flash memory until the flash memory responds to the host that the data has been successfully read from the flash memory or a read failure occurs. Similarly, when the host issues a data writing command to the flash memory, the host will not issue the next data reading or writing command to the flash memory until the flash memory responds to the host that the data has been successfully written into the flash memory or a write failure occurs.

Since the controller for the flash memory can receive a data accessing command (e.g. a data reading or writing command) at a time, the controller fails to foresee what the next data accessing command is. FIG. 1 is a table relating to the contents of the data accessing commands sequentially issued from the host terminal to the flash memory controller. Assuming that the host terminal sequentially issue 11 data accessing commands to the flash memory controller, the flash memory will execute eleven data reading or writing operations in a predetermined sequence shown in this table. Under this circumstance, the amount of data to be processed by the flash memory controller at each time is passively determined by the host terminal.

Please refer to FIG. 1 again. The contents of each data accessing command include the command type, the logic block addressing (LBA) and the sector count. Assuming that the amount of data contained in a page of the flash memory is 2 k bytes, a method of computing the total time period of executing these eleven data reading or writing operations is performed by the following steps: (1) in response to the first command for reading the data having the amount of 2 sectors (1 k bytes<1 page) and starting from LBA=0, the flash memory needs a random read latency of 25 μs; (2) in response to the second command for writing the data having the amount of 1 sector (0.5 k bytes) and starting from LBA=20, the flash memory needs a block erase period of 1.5 ms and a write latency of 200 μs; (3) in response to the third command for reading the data having the amount of 2 sectors (1 k bytes<1 page) and starting from LBA=2, the flash memory needs a random read latency of 25 μs; (4) in response to the fourth command for writing the data having the amount of 1 sector (0.5 k bytes) and starting from LBA=22, the flash memory such that the flash memory needs a write latency of 200 μs; (5) in response to the fifth command for reading the data having the amount of 3 sectors (1.5 k bytes<1 page) and starting from LBA=10, the flash memory needs a random read latency of 25 μs; (6) in response to the sixth command for reading the data having the amount of 5 sectors (2.5 k bytes>1 page) and starting from LBA=13, the flash memory needs a random read latency of 25 μs and a sequential read latency of 25 ns; (7) in response to the seventh command for writing the data having the amount of 5 sectors (2.5 k bytes>1 page) and starting from LBA=23, the flash memory needs two write latencies of 400 μs; (8) in response to the eighth command for writing the data having the amount of 2 sectors and starting from LBA=28, the flash memory needs a write latency of 200 μs; (9) in response to the ninth command for reading the data having the amount of 2 sectors (1 k bytes<1 page) and starting from LBA=18, the flash memory needs a random read latency of 25 μs; (10) in response to the tenth command for writing the data having the amount of 2 sectors and starting from LBA=30, the flash memory needs a write latency of 200 μs; and (11) in response to the eleventh command for writing the data having the amount of 2 sectors and starting from LBA=32, the flash memory needs a write latency of 200 μs.

For writing the data of 6.5 k bytes, a block erase period and seven read latencies are required and thus the total time period of executing the data writing operation is 2.9 mS (1.5 mS+0.2mS×7=2.9 mS). Whereas, for reading the data of 7 k bytes, five random read latencies and one sequential read latency are required and thus the total time period of executing the data reading operation is 125.025 μs (2.9 mS+125.025 μs=3.025025 mS). That is, it takes 3.025025 mS (2.9 mS+125.025 μs=3.025025 mS) to execute all of the data accessing commands.

Recently, the flash memory is provided with a buffer in order to increase the data accessing speed. When the host terminal issues a data read command to the flash memory, the data read command is pre-fetched in the buffer and thus the read latency is reduced. This approach, however, fails to increase the writing efficiency. Consequently, the improvement of the overall data accessing efficiency is unsatisfactory.

Therefore, there is a need of providing a method of integrating data accessing commands so to increase the accessing efficiency of the flash memory.

### SUMMARY OF THE INVENTION

The present invention provides a data accessing command integration method for use with a data memory. The data accessing command integration method includes the following steps. Firstly, M data accessing commands are sequentially received through a bus, wherein N data accessing commands contained in the M data accessing commands have the same command type and comply with a sequential address relationship. Next, the N data accessing commands are re-ordered according to the addressing sequence, so that a first data corresponding to the re-ordered N data accessing commands are sequentially accessed in the data memory.

The present invention also provides a data access device for accessing data to a data memory. The data access device includes a command queue and a control program. The command queue sequentially receives M data accessing commands through a bus, wherein N data accessing commands contained in the M data accessing commands have the same command type and comply with a sequential address relationship. The control program is connected to the command queue for re-ordering the N data accessing commands according to the addressing sequence, so that a first data corresponding to the re-ordered N data accessing commands are sequentially accessed in the data memory.

The present invention also provides a data accessing command integration system. The data accessing command integration system includes a host, a bus, a data access device and a data memory. The host sequentially issues M data accessing commands, wherein N data accessing commands contained in the M data accessing commands have the same command type and comply with a sequential address relationship. The bus is electrically connected to the host. The data access device is used for receiving M data accessing commands through the bus and re-ordering the N data accessing commands according to the addressing sequence. The data memory is accessed by a first data corresponding to the re-ordered N data accessing commands.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a table relating to the contents of the data accessing commands sequentially issued from the host terminal to the flash memory controller;

FIG. 2 is a functional block diagram illustrating a data access merging system according to a preferred embodiment of the present invention;

FIG. 3 is a flowchart of a data accessing command integration method according to the present invention; and

FIG. 4 is a table relating to the contents of the merged data accessing commands in the command queue.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

For increasing the data reading/writing speed between the host terminal and the storage device, the conventional ATA bus has been gradually replaced by the Serial Advanced Technology Attachment (SATA) bus. As known, Native Command Queuing (NCQ) is a feature of SATA. NCQ is a technology designed to increase performance of SATA storage devices under certain situations by allowing the individual storage device to simultaneously receive multiple data accessing commands and optimize the order of the data accessing commands.

In addition to the NCQ function, the present invention has an additional function of merging multiple data reading commands or date writing commands whose access addresses comply with a sequential address relationship, so that the data accessing speed is enhanced when the sequential accessing operations are executed. In particular, the data reading commands or the date writing commands are sequentially received by a command queue at different time spots and then re-ordered by a control program, so that the data corresponding to the re-ordered data accessing commands are sequentially accessed in the data memory. Consequently, the total time period of executing the data reading operation and the data writing operation is reduced.

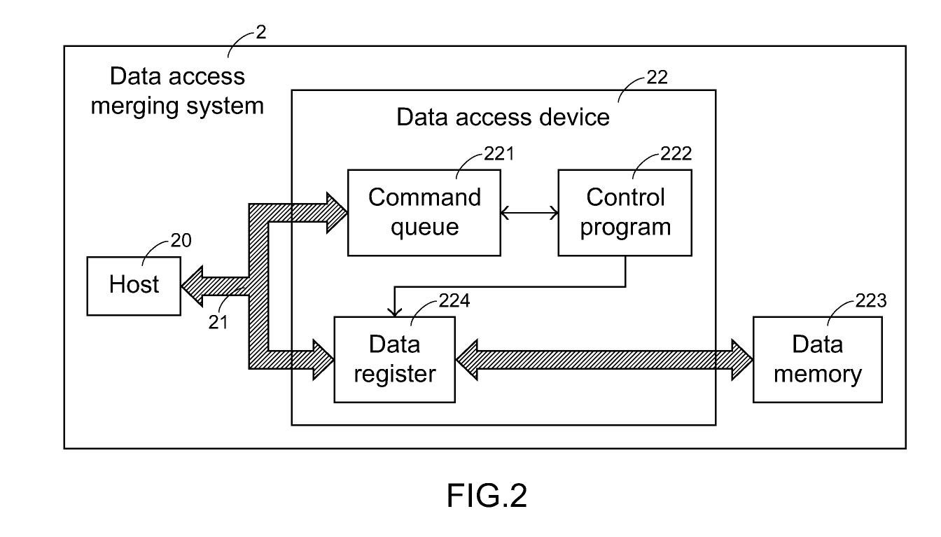

FIG. 2 is a functional block diagram illustrating a data access merging system according to a preferred embodiment of the present invention. The data access merging system 2 of FIG. 2 principally comprises a host 20, a bus 21, a data access device 22 and a data memory 223. The data access device 22 comprises a command queue 221, a control program 222 and a data register 224.

When the host 20 issues M data accessing commands to the data access device 22 through the bus 21, the command queue 221 sequentially receives these M data accessing commands. Depending on the command types, these M data accessing commands are classified into two types, i.e. data reading commands and data writing commands. The control program 222 is connected to the command queue 221. In a case N data accessing commands having the same command type and complying with a sequential address relationship, the control program 222 will re-order these N data accessing commands. For executing the data accessing operations, the control program 222 issues a control signal to the data register 224. In response to the control signal, first data corresponding to the N data accessing commands are sequentially accessed in the data memory 223. An exemplary data memory 223 is a flash memory.

For example, the host 20 sequentially issues M data accessing commands to the data access device 22 through the bus 21 at different time spots. These M data accessing commands are sequentially received by the command queue 221 of the data access device 22. In this embodiment, these M data accessing commands include N data reading commands and K data writing commands. In a case the N data reading commands and the K data writing commands comply with respective sequential address relationships, the control program 222 will re-order the N data reading commands and the K data writing commands. If the number of the N data reading commands or the K data writing commands reaches the maximum storable number of the command queue 221, first data corresponding to the N data reading commands and second data corresponding to the K data writing commands will be one after another or simultaneously accessed in the data memory 223. After the first data and the second data are accessed in the data memory 223, new data accessing commands are sequentially received by the command queue 221 of the data access device 22 and the control program 222 will re-order the data accessing commands.

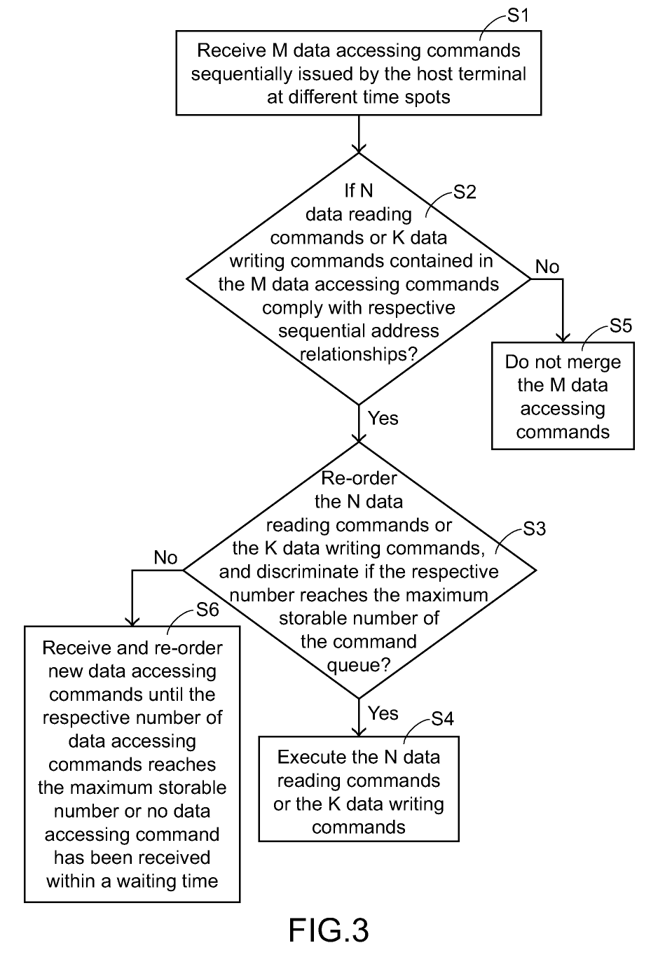

Hereinafter, a data accessing command integration method of the present invention will be illustrated with reference to a flowchart of FIG. 3. The data access merging method is applied to the data access device 22 and the data memory 223. First of all, M data accessing commands sequentially issued by the host terminal at different time spots are received by the data access device 22 (Step S1). If N data reading commands or K data writing commands contained in the M data accessing commands comply with respective sequential address relationships (Step S2), the control program 222 will re-order the N data reading commands or the K data writing commands such that the N data reading commands or the K data writing commands are merged together. Meanwhile, the data accessing speed is enhanced when the sequential accessing operations are executed. Next, the control program 222 discriminates whether the number of the N data reading commands or the K data writing commands reaches the maximum storable number (e.g. eight) of the command queue 221 (Step S3). Otherwise, if the N data reading commands or the K data writing commands contained in the M data accessing commands fail to comply with respective sequential address relationships, the M data accessing commands will not be merged (Step S5).

Furthermore, if the number of the N data reading commands or the K data writing commands reaches the maximum storable number of the command queue 221 (Step S3), the N data reading commands or the K data writing commands are executed such that the first data corresponding to the re-ordered N data reading commands or the second data corresponding to the re-ordered K data writing commands are accessed in the data memory 223 (Step S4). Otherwise, if the number of the N data reading commands or the K data writing commands does not reach the maximum storable number of the command queue 221, other non-sequential data accessing commands are executed and new data accessing commands are sequentially received by the command queue 221. The new data accessing commands complying with a sequential address relationship will be re-ordered and merged together until the number of data accessing commands reaches the maximum storable number of the command queue 221 or no data accessing command has been received within a waiting time (Step S6).

From the above description, it is found that the data accessing command integration method of the present invention is effective to reduce the time period required for performing the data reading operation and the data writing operation. As previously described in the prior art, the data reading or writing commands issued by the host terminal are successively processed one by one and thus the overall accessing efficiency is unsatisfied. According to the present invention, NCQ is used to increase performance of the SATA bus. In addition, the data reading commands or the date writing commands whose access addresses comply with a sequential address relationship are sequentially received by a command queue and then re-ordered by a control program, so that the data corresponding to the re-ordered data accessing commands are sequentially accessed in the data memory. Consequently, the total time period of executing the data reading operation and the data writing operation is reduced.

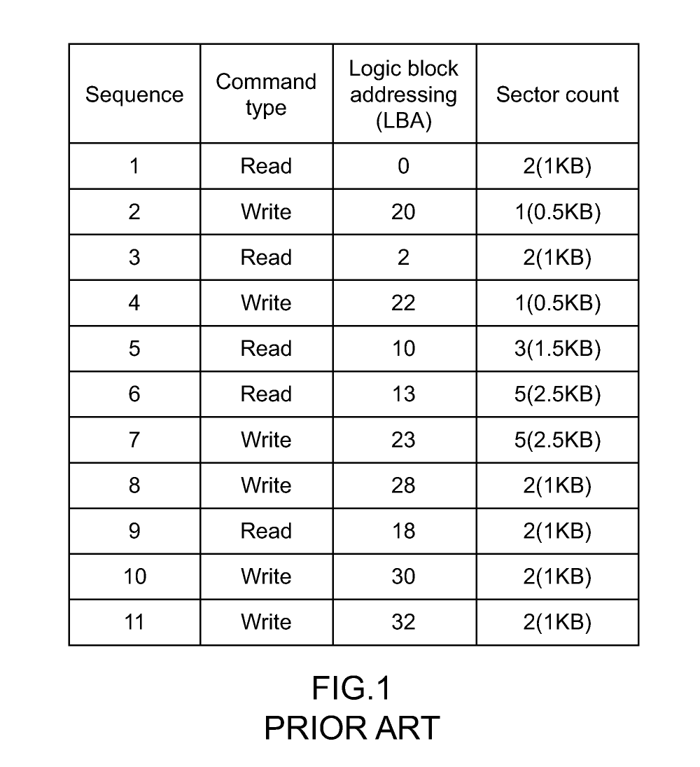

As previously described in FIG. 1, in response to the eleven data accessing commands sequentially issued from the host terminal the flash memory controller, the flash memory will execute eleven data reading or writing operations in a predetermined sequence. According to the present invention, the data accessing commands are transmitted from the host terminal to the data access device through the SATA bus. In addition, the data reading or writing command is transferred in sectors (a sector=256 Words=512 bytes=0.5 kB) at a time. The preset data length (one page) is 2 k bytes (or 4 k bytes or 8 k bytes). The command queue 222 can temporarily store at most eight data accessing commands. Hereinafter, the data accessing command integration method of the present invention will be illustrated with reference to the following steps: (1) in response to the first command for reading the data having the amount of 2 sectors (1 k bytes<1 page) and starting from LBA=0, the first command is temporarily stored in the command queue; (2) in response to the second command for writing the data having the amount of 1 sector and starting from LBA=20, the second command is temporarily stored in the command queue; (3) in response to the third command for reading the data having the amount of 2 sectors (1 k bytes<1 page) and starting from LBA=2, the first command and the third command are merged and re-ordered for reading the data having the amount of 4 sectors (2 k bytes=1 page) and starting from LBA=2 because the first command and the third command are both data reading commands and comply with a sequential address relationship; (4) in response to the fourth command for writing the data having the amount of 1 sector and starting from LBA=22, the fourth command is temporarily stored in the command queue; (5) in response to the fifth command for reading the data having the amount of 3 sectors (1.5 k bytes<1 page) and starting from LBA=10, the fifth command is temporarily stored in the command queue; (6) in response to the sixth command for reading the data having the amount of 5 sectors (2.5 k bytes>1 page) and starting from LBA=13, the fifth command and the sixth command are merged and re-ordered for reading the data having the amount of 8 sectors (4 k bytes=4 page) and starting from LBA=10 because the fifth command and the sixth command are both data reading commands and comply with a sequential address relationship; (7) in response to the fourth command for writing the data having the amount of 5 sectors and starting from LBA=23, the fourth command and the seventh command are merged and re-ordered for writing the data having the amount of 6 sectors (3 k bytes=1.5 page) and starting from LBA=22 because the fourth command and the seventh command are both data writing commands and comply with a sequential address relationship; (8) in response to the eighth command for writing the data having the amount of 2 sectors and starting from LBA=28, the fourth, seventh and eighth commands are merged and re-ordered for writing the data having the amount of 8 sectors (4 k bytes=2 page) and starting from LBA=22 because the fourth, seventh and eighth commands are all data writing commands and comply with a sequential address relationship; (9) in response to the ninth command for reading the data having the amount of 2 sectors (1 k bytes<1 page) and starting from LBA=18, the fifth, sixth and ninth commands are merged and re-ordered for reading the data having the amount of 10 sectors (5 k bytes=2.5 page) and starting from LBA=22 because the fifth, sixth and ninth commands are all data reading commands and comply with a sequential address relationship; (10) in response to the tenth command for writing the data having the amount of 2 sectors and starting from LBA=30, the fourth, seventh, eighth and tenth commands are merged and re-ordered for writing the data having the amount of 10 sectors (5 k bytes=2.5 page) and starting from LBA=22 because the fourth, seventh, eighth and tenth commands are all data writing commands and comply with a sequential address relationship; and (11) in response to the eleventh command for writing the data having the amount of 2 sectors and starting from LBA=32, the fourth, seventh, eighth, tenth and eleventh commands are merged and re-ordered for writing the data having the amount of 12 sectors (6 k bytes=3 page) and starting from LBA=22 because the fourth, seventh, eighth, tenth and eleventh commands are all data writing commands and comply with a sequential address relationship.

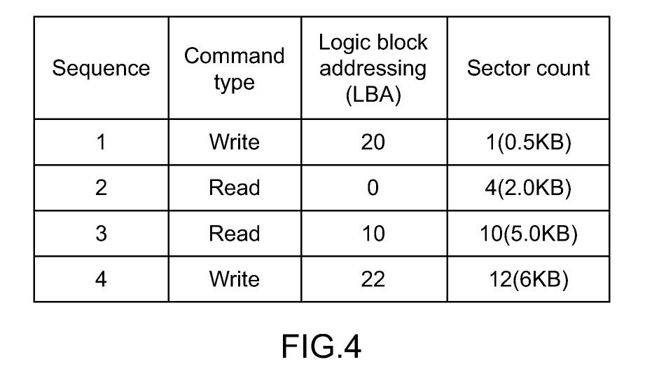

FIG. 4 is a table relating to the contents of the merged data accessing commands in the command queue. By the data accessing command integration method of the present invention, the original eleven data accessing commands are processed into four merged data accessing commands. A method of computing the total time period of executing these four merged data accessing commands is performed by the following steps: (1) in response to the first command for writing the data having the amount of 1 sector (0.5 k bytes<1 page) and starting from LBA=20, the flash memory needs a block erase period of 1.5 ms and a write latency of 200 μs; (2) in response to the second command (merged by two original data accessing commands having sequential addresses) for reading the data having the amount of 4 sectors (2 k bytes=1 page) and starting from LBA=0, the flash memory needs a random read latency of 25 μs; (3) in response to the third command (merged by three original data accessing commands having sequential addresses) for reading the data having the amount of 10 sectors (5 k bytes=2.5 pages) and starting from LBA=10, the flash memory needs a random read latency of 25 μs for reading the first page, a sequential read latency of 25 ns for reading the second page and a sequential read latency of 25 ns for reading the third page (0.5 page) because the third and second data accessing commands do not have the sequential addresses; and (4) in response to the fourth command (merged by five original data accessing commands having sequential addresses) for writing the data having the amount of 12 sectors (6 k bytes=3 page) and starting from LBA=20, the flash memory needs a write latency of 3×200 μs for writing three pages.

For writing the data of 6.5 k bytes, a block erase period and a read latency for reading four pages are required and thus the total time period of executing the data writing operation is 2.9 mS (1.5 mS+0.2mS×4=2.3 mS). Whereas, for reading the data of 7 k bytes, two random read latencies and two sequential read latency are required and thus the total time period of executing the data reading operation is 50.05 μs (25 μs×2+25 nS×2=50.05 μs). That is, it takes 2.35005 mS (2.3 mS+50.05 μs=2.35005 mS) to execute all of the data accessing commands. In comparison with the conventional technology, the data accessing command integration method of the present invention saves 674.975 μs (3.025025 mS−2.35005 mS=674.975 μs).

Since the fourth merged data accessing commands have different addresses, the data corresponding to any merged data accessing command may be accessed in the data memory under control of the control program. Alternatively, if the data reading command and the data writing command have the same address, the data reading command and the data writing command should be executed one after another without the need of merging with other data accessing commands for re-ordering. Moreover, if the number of the N data accessing commands reaches a maximum storable number of the command queue, the data corresponding to any merged data accessing command should be accessed in the data memory and then other data accessing commands are re-ordered.

The data accessing command integration method of the present invention is illustrated by referring to a flash memory. Nevertheless, the concepts of the present invention may be applied to any SATA storage device such as hard disc drive, optical disc drive and the like.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data accessing command integration method for use with a data memory, comprising steps of:
sequentially receiving M data accessing commands through a bus, wherein N data accessing commands contained in the M data accessing commands have the same command type and comply with a sequential address relationship; and
re-ordering the N data accessing commands according to the addressing sequence, so that a first data corresponding to the re-ordered N data accessing commands are sequentially accessed in the data memory.

2. The data accessing command integration method according to claim 1 wherein the M data accessing commands comprise a plurality of data reading commands and a plurality of data writing commands.

3. The data accessing command integration method according to claim 2 wherein if a specified one of the plurality of data reading commands and a specified one of the plurality of data writing commands have the same address, the specified data reading command and the specified data writing command are successively accessed without being merged with other data accessing commands for re-ordering.

4. The data accessing command integration method according to claim 1 wherein if the number of the N data accessing commands reaches a maximum storable number, the first data are accessed in the data memory and then other data accessing commands are re-ordered.

5. The data accessing command integration method according to claim 1 wherein the M data accessing commands further comprise K data accessing commands having the same command type and complying with a sequential address relationship, the K data accessing commands and the N data accessing commands have different command types, and the K data accessing commands are re-ordered according to the addressing sequence, so that a second data corresponding to the re-ordered K data accessing commands are sequentially accessed in the data memory.

6. The data accessing command integration method according to claim 5 wherein if the number of the N data accessing commands or the K data accessing commands reaches a maximum storable number, the first data or the second data are accessed in the data memory and then other data accessing commands are re-ordered.

7. The data accessing command integration method according to claim 1 wherein the bus is a Serial Advanced Technology Attachment bus.

8. The data accessing command integration method according to claim 1 wherein the data memory is a flash memory.

9. A data access device for accessing data to a data memory, the data access device comprising:
a command queue sequentially receiving M data accessing commands through a bus, wherein N data accessing commands contained in the M data accessing commands have the same command type and comply with a sequential address relationship; and
a control program connected to the command queue for re-ordering the N data accessing commands according to the addressing sequence, so that a first data corresponding to the re-ordered N data accessing commands are sequentially accessed in the data memory.

10. The data access device according to claim 9 further comprising a data register connected to the bus and the data memory, wherein the first data are accessed in the data memory through the data register under control of the control program.

11. The data access device according to claim 9 wherein the M data accessing commands comprise data reading commands and data writing commands.

12. The data access device according to claim 11 wherein if a specified one of the data reading commands and a specified one of the data writing commands have the same address, the specified data reading command and the specified data writing command are successively accessed without being merged with other data accessing commands for re-ordering.

13. The data access device according to claim 9 wherein if the number of the N data accessing commands reaches a maximum storable number, the first data are accessed in the data memory and then other data accessing commands are re-ordered.

14. The data access device according to claim 9 wherein the M data accessing commands further comprise K data accessing commands having the same command type and complying with a sequential address relationship, the K data accessing commands and the N data accessing commands have different command types, and the K data accessing commands are re-ordered according to the addressing sequence, so that second data corresponding to the re-ordered K data accessing commands are sequentially accessed in the data memory.

15. The data access device according to claim 14 wherein if the number of the N data accessing commands or the K data accessing commands reaches a maximum storable number, the first data or the second data are accessed in the data memory and then other data accessing commands are re-ordered.

16. The data access device according to claim 9 wherein the bus is a Serial Advanced Technology Attachment bus.

17. The data access device according to claim 9 wherein the data memory is a flash memory.

18. A data accessing command integration system, comprising:
a host sequentially issues M data accessing commands, wherein N data accessing commands contained in the M data accessing commands have the same command type and comply with a sequential address relationship;
a bus electrically connected to the host;
a data access device for receiving M data accessing commands through the bus and re-ordering the N data accessing commands according to the addressing sequence; and
a data memory accessed by a first data corresponding to the re-ordered N data accessing commands.

19. The data accessing command integration system according to claim 18 wherein if the number of the N data accessing commands reaches a maximum storable number, the data access device controls the first data to be accessed in the data memory.

20. The data accessing command integration system according to claim 18 wherein the data access device comprises:
a command queue electrically connected to the bus for temporarily storing the M data accessing commands; and
a control program electrically connected to the command queue for re-ordering the N data accessing commands, so that first data corresponding to the re-ordered N data accessing commands are sequentially accessed in the data memory.
